(19) United States
(12) Patent Application Publication
(10) Pub. No.: US 2026/0233747 A1
(43) Pub. Date: Aug. 13, 2026

(54) Apparatus and Method for Non-Intrusive, Tamper-Evident Logging and Exxplanation of ADAS Interventions

(71) Applicant: Vincent Loccisano, Wellesley, MA (US)

(72) Inventor: Vincent Loccisano, Wellesley, MA (US)

(21) Appl. No.: 19/640,654

(22) Filed: Apr. 7, 2026

(51) Int. Cl. B60W 50/04; B60W 30/09; B60W 30/12; B60W 30/14; B60W 50/00; B60W 50/10; B60W 60/00; G06F 8/65; G07C 5/04; H04L 9/08; H04L 9/32

(52) U.S. Cl. CPC B60W 50/045; B60W 30/12; B60W 30/14; B60W 50/0098; B60W 50/10; B60W 60/0053; G06F 8/65; G07C 5/04; H04L 9/088; H04L 9/3247; B60W 30/09; B60W 2050/0022; B60W 2050/0083; B60W 2050/046; B60W 2556/45

(57) ABSTRACT

An advanced driver assistance system (ADAS) intervention logging system provides a non-intrusive, tamper-evident record of automated driving decisions. An intervention event detector identifies qualifying events and freezes a pre-event sensor buffer to preserve environmental context. An inference trace recorder captures internal logic and feature attributions via shared-memory observation hooks to generate a structured causal narrative without introducing latency to the ADAS pipeline. A counterfactual action logger documents rejected alternative maneuvers and their feasibility classifications. A tamper-evident audit chain manager compiles these data into an explainable intervention record (EIR), which is cryptographically linked in an append-only chain, signed by a hardware security module, and stored in write-once non-volatile memory. The system further includes a regulatory compliance engine and role-based access control for secure data extraction via diagnostic or telematics channels.

### FIELD OF INVENTION

The present disclosure relates generally to the field of autonomous vehicle control and data recording systems. More particularly, the present disclosure relates to a non-intrusive, tamper-evident logging architecture for capturing, explaining, and securing data associated with Advanced Driver Assistance System (ADAS) interventions and autonomous driving decisions through the use of shared-memory observation hooks, structured causal narratives, and cryptographically linked audit chain.

### BACKGROUND

Modern Advanced Driver Assistance Systems (ADAS) and autonomous driving platforms increasingly rely on high-capacity deep learning architectures, such as convolutional neural networks for perception and transformer-based models for temporal prediction. While these models often exceed the performance of traditional rule-based logic, they are fundamentally characterized by an internal “black-box” opacity. In a typical inference cycle, the specific activation patterns and weight distributions that result in a safety-critical command—such as emergency braking or a high-speed swerve—exist only as volatile floating-point values within high-speed memory. Because these values are typically overwritten within milliseconds to make room for the next inference cycle, the system fails to produce a human-readable or machine-auditable rationale for its actions as a natural output of its computation.

This lack of transparency is compounded by the limitations of current vehicle Event Data Recorders (EDRs), which are primarily governed by standards like NHTSA 49 CFR Part 563 and UN Regulation 160. Existing EDRs are designed to capture physical vehicle state data, such as longitudinal delta-V, throttle position, and steering angle, within a narrow temporal window surrounding a collision. However, these records are insufficient for modern AI-driven vehicles because they document only the physical outcomes of a decision rather than the logical derivation of that decision. Current systems do not record the specific sensor inputs or feature maps that triggered a high-confidence detection, the internal computational pathways traversed by the AI model, or the alternative trajectories that the planning module considered and rejected. Consequently, while current telemetry can answer what the vehicle did, it remains incapable of explaining why the system initiated a specific intervention.

The technical gap in AI explainability has created a significant structural challenge within an increasingly stringent regulatory environment. Under the EU AI Act (Regulation 2024/1689), which is fully effective as of 2026, safety-critical AI systems in transport are classified as high-risk, imposing mandatory requirements for automatic logging, technical transparency, and human oversight. Similarly, in the United States, the implementation of FMVSS 127—which mandates Automatic Emergency Braking in all new passenger vehicles by 2029—and the evolving NHTSA Automated Vehicle 4.0 framework have heightened the demand for incident transparency. Without a structured, machine-readable record of AI reasoning, Original Equipment Manufacturers (OEMs) face substantial legal and commercial liability, as investigators, insurers, and courts cannot determine whether an adverse event was the result of a perception failure, a calibration error, or an unforeseen edge-case behavior.

To address these deficiencies, there is a clear technical need for a unified, vehicle-embedded architecture capable of generating a synchronous, tamper-evident record of every ADAS intervention. Such a system must integrate the specific sensor inputs and pre-processed features that triggered a decision with a computational trace of the AI's internal logic. Furthermore, the architecture must provide a record of rejected alternative actions—including their associated cost decompositions—and synthesize this complex data into a structured, human-readable causal narrative. To ensure regulatory and evidentiary utility, these records must be mapped against applicable safety standards and secured via a cryptographically signed, append-only ledger. The present invention provides this integrated logging and explainability architecture to bridge the gap between autonomous inference and regulatory accountability.

### SUMMARY

In an example embodiment, the present invention provides a non-intrusive, tamper-evident logging system designed to act as a permanent record for Advanced Driver Assistance Systems (ADAS). The system creates a transparent, legally interpretable record of every instance where a vehicle's automated features such as autonomous emergency braking (AEB), lane-keeping assist (LKA), or adaptive cruise control (ACC) override or assist the driver. Unlike traditional recorders, this system operates as a secondary framework that monitors the vehicle's decision-making pipeline through high-speed, non-blocking data taps. This allows it to capture deep internal logic and environmental context without slowing down the vehicle's critical safety functions or requiring modifications to the original software code.

The process begins with a specialized detector that identifies qualifying intervention events, such as a sudden collision warning or an unplanned disengagement of autonomous mode. To provide a complete picture of the event, the system maintains a rolling five-second buffer of processed sensor data—essentially a snapshot of what the car “perceived” in its surroundings—which is frozen and saved the moment an intervention occurs.

The system uses an inference trace recorder. This component documents the specific inputs and internal triggers that led to a decision, translating complex computational data into a human-readable “Structured Causal Narrative.” This narrative follows a standardized format that describes the pre-conditions, the specific trigger, the logic path taken, the action executed, and the final outcome. The system is designed to be universal, working equally well with traditional rule-based software, neural networks, or end-to-end learned AI models.

The system also logs “counterfactual” actions which are the alternative maneuvers the car considered but ultimately rejected. By capturing the estimated risks and costs (such as passenger comfort versus collision probability) for these rejected paths, the logger can justify why the chosen action was the safest available. It specifically classifies alternatives as feasible, physically blocked, or outside the system's search area, providing a vital factual basis for defending a vehicle's actions in legal or regulatory reviews.

Every recorded event is compiled into a comprehensive “Explainable Intervention Record” and secured using a tamper-evident audit chain. Each new record is mathematically linked to the one before it; using cryptographic hashes, making it impossible to delete or alter the history without detection. These records are signed using a secure, non-copyable digital key stored in the vehicle's hardware security module and saved to specialized “write-once” memory. This creates an immutable, lifelong ledger of vehicle behavior that can be independently verified by authorized third parties.

The system includes a reporting engine that maps vehicle actions against specific global safety regulations to provide an instant compliance status. These findings are summarized in structured reports tailored for regulators, insurance adjusters, or legal professionals. To protect privacy, a role-based access system ensures that different stakeholders only see the data they are authorized to view—ranging from a simple summary for the vehicle owner to full forensic data for a court-ordered investigation—accessible via standard diagnostic ports or encrypted wireless channels.

An intervention event detector monitors the ADAS arbitration layer to identify qualifying intervention events—defined as any instance in which the ADAS system overrides, assists, or materially modifies driver-commanded or default vehicle behavior—and classifies each event by type including Autonomous Emergency Braking (AEB) activation, Lane Keeping Assist (LKA) active correction, Adaptive Cruise Control (ACC) intervention, collision warning override, driver override of ADAS command, and autonomous mode disengagement. The detector maintains a rolling pre-event sensor buffer of configurable depth and freezes this buffer upon detection of a qualifying event.

An inference trace recorder captures, using a non-intrusive instrumentation architecture based on shared-memory observation hooks, the sensor inputs active at the time of each intervention, the intermediate feature representations or decision-relevant activations at each stage of the ADAS processing pipeline, and the feature attribution data identifying which inputs most strongly drove the action. The recorder is model-agnostic, supporting rule-based, modular neural, and end-to-end learned ADAS architectures without requiring source code modifications to the ADAS model. From these captured data, the recorder generates a Structured Causal Narrative (SCN) following a fixed schema.

A counterfactual action logger captures the top-N alternative actions evaluated by the ADAS planning module in the decision cycle that produced each intervention, together with the estimated cost decomposition for each alternative, the feasibility classification of each, and the reason the executed action was selected over the alternatives. A regulatory compliance annotation engine maps the executed action and its decision rationale to applicable safety regulations and generates an intervention compliance status annotation.

A tamper-evident audit chain manager formats each intervention event into a complete Explainable Intervention Record (EIR) comprising all captured data fields, computes a cryptographic hash chain linking each EIR to its predecessor, signs each EIR using a private key stored in the vehicle's hardware security module (HSM) such that the private key is non-exportable from the HSM, and writes the signed record to write-once non-volatile memory (WORM NVM). The resulting Audit Chain can be independently verified by any authorized party in possession of the vehicle's public key certificate.

### BRIEF DESCRIPTION OF DRAWINGS

FIG. 1 is a system architecture block diagram or the present invention.

FIG. 2 is a schematic diagram of the Explainable Intervention Record (EIR) data structure.

FIG. 3 is a diagram illustrating the tamper-evident Audit Chain data structure.

FIG. 4 is a diagram illustrating non-intrusive instrumentation architecture.

FIG. 5 is a side-by-side comparison diagram showing the inference trace capture output.

FIG. 6 is a counterfactual action log example showing a logged AEB intervention with five alternative actions.

FIG. 7 is a representative Compliance Summary Report layout.

FIG. 8 is a diagram illustrating the role-based access control and EIR extraction workflow.

### DESCRIPTION

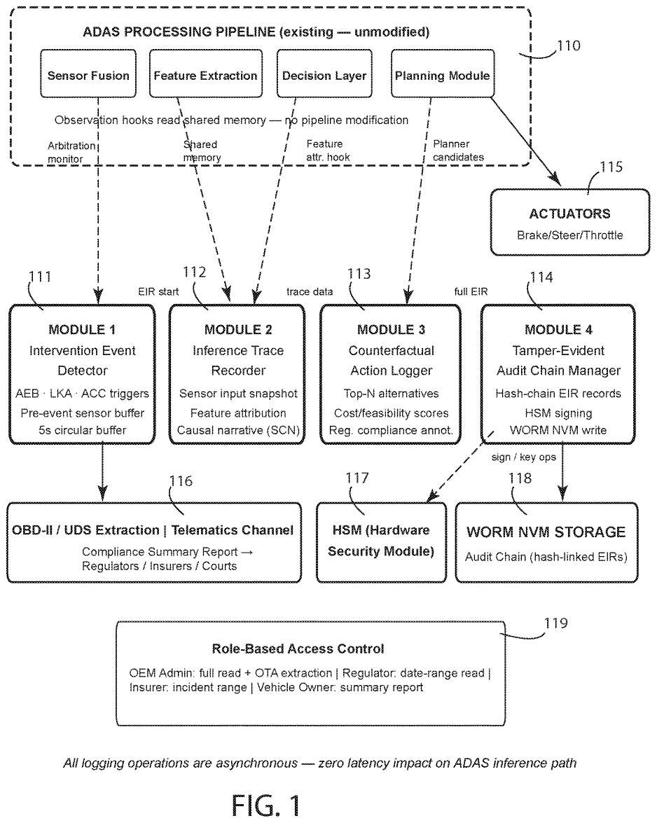

As illustrated in FIG. 1, the system is architected as a non-intrusive logging framework that monitors an existing ADAS Processing Pipeline 110. This pipeline, which remains unmodified by the logging system, consists of various functional layers including sensor fusion, feature extraction, a decision layer, and a planning module that ultimately directs the vehicle's Actuators 115. By utilizing shared-memory observation hooks, the system extracts critical data without introducing latency into the primary inference path. The process begins with the Intervention Event Detector 111, which monitors the arbitration layer to identify specific triggers such as Autonomous Emergency Braking or Lane Keeping Assist. Upon identifying a qualifying event, this module freezes a rolling pre-event sensor buffer to ensure the environmental context leading up to the intervention is preserved for later analysis.

Data regarding the internal logic of the decision is then captured by the Inference Trace Recorder 112, which documents the specific sensor inputs and feature attributions that drove the system's response. This module generates a Structured Causal Narrative to explain the model's reasoning in a standardized format. Simultaneously, the Counterfactual Action Logger 113 records the alternative trajectories or actions that were considered but ultimately rejected by the planning module. This logger includes cost-decomposition data and feasibility scores, mapping these decisions against a regulatory compliance engine to provide a status annotation for each action.

The management of these records is handled by the Tamper-Evident Audit Chain Manager 114, which compiles the collected data into a comprehensive Explainable Intervention Record (EIR). To ensure the integrity of the data, the manager computes a cryptographic hash chain that links each EIR to its predecessor and signs the record using a non-exportable private key housed within the Hardware Security Module 117. These secured records are then written to a write-once non-volatile memory WORM NVM Storage 118, creating a permanent, immutable ledger of vehicle behavior. Authorized parties can extract this information through an OBD-II or Telematics Channel 116 in the form of a Compliance Summary Report. Access to this sensitive data is governed by a Role-Based Access Control 119 layer, which restricts the depth of information available to different stakeholders, such as regulators, insurers, and vehicle owners, based on their specific legal or operational requirements.

The Intervention Event Detector 111 serves as a continuous monitoring process that observes the ADAS arbitration layer to identify qualifying intervention events. The arbitration layer acts as the primary software intermediary, resolving conflicts between driver inputs, ADAS recommendations, and default vehicle behaviors to generate the final commands sent to the Actuators 115. By monitoring this layer via non-intrusive observation hooks, the Intervention Event Detector 111 detects instances where the ADAS system's recommended action materially deviates from the driver's intent or the vehicle's default state.

The system is configured to classify a variety of specific intervention types. These include Autonomous Emergency Braking (AEB), triggered when braking force exceeds 0.3 g without driver input, and Lane Keeping Assist (LKA), characterized by steering torque applied to counteract lane departure. It also captures Adaptive Cruise Control (ACC) interventions that exceed set parameters, Collision Warning Overrides where a driver responds to an alert within one second, and instances where a driver manually overrides an active ADAS command. Additionally, the detector logs Autonomous Mode Disengagement, capturing any unplanned transitions from Level 3 or higher autonomous driving modes, whether initiated by the driver or the system itself.

To preserve the context of these events, the Intervention Event Detector 111 maintains a rolling pre-event sensor buffer. This buffer, typically configured to store five seconds of data, is implemented as a lock-free circular buffer in protected memory. Rather than recording raw data, it captures compressed representations of the sensor fusion output—specifically the fused object list containing positions, velocities, and confidence scores—at the system's native update rate. This approach ensures the record reflects exactly what the ADAS pipeline perceived leading up to the decision. Upon the detection of a qualifying event, the write pointer is atomically halted, freezing the buffer and committing its contents to a protected snapshot. This snapshot is then passed to the Inference Trace Recorder 112 for integration into the final Explainable Intervention Record (EIR).

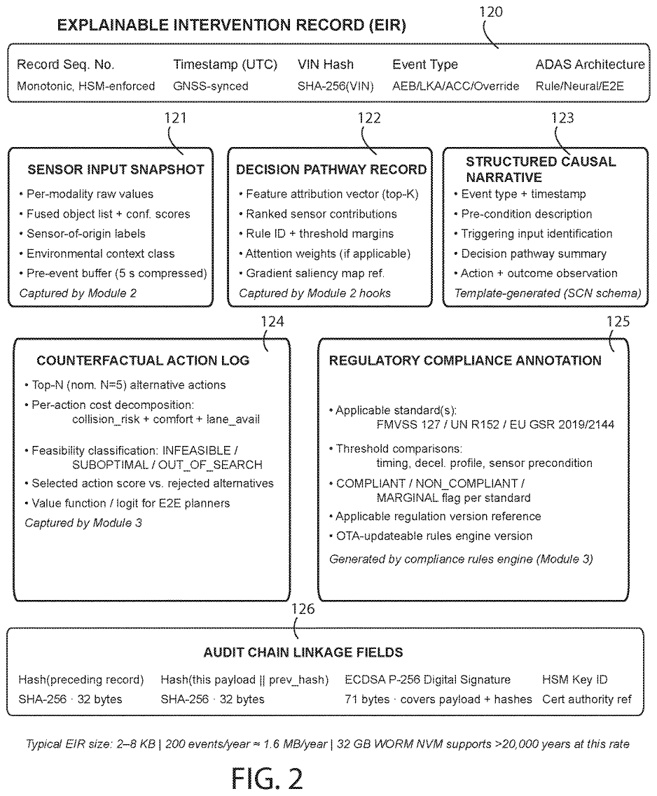

FIG. 2 is a structured schema diagram of the Explainable Intervention Record (EIR) data structure 120, showing all payload sections: the EIR header fields, the Sensor Input Snapshot 121, the Decision Pathway Record 122, the Structured Causal Narrative 123, the Counterfactual Action Log 124, the Regulatory Compliance Annotation 125, and the Audit Chain linkage fields 126 including cryptographic hash and digital signature.

The Explainable Intervention Record (EIR) 120, is part of a multi-layered data structure that constitutes a single audit event. At the top of the hierarchy, the EIR header fields establish the fundamental identity of the record, containing a monotonic, HSM-enforced sequence number, a GNSS-synced UTC timestamp, a SHA-256 hash of the Vehicle Identification Number (VIN), the event classification (e.g., AEB or LKA), and the specific ADAS architecture type in use.

The record is composed of several distinct payload sections, beginning with the Sensor Input Snapshot 121. This section, captured by the Inference Trace Recorder 112, contains raw values, fused object lists with associated confidence scores, and the five-second compressed pre-event buffer to provide full environmental context. Complementing this is the Decision Pathway Record 122, which logs internal processing data such as feature attribution vectors, ranked sensor contributions, and gradient saliency map references to explain the internal logic of the ADAS model.

The qualitative reasoning of the system is encapsulated in the Structured Causal Narrative 123, a template-generated summary that describes the pre-conditions, triggering inputs, and the final action-outcome observation following a standardized SCN schema. Comparative analysis is provided by the Counterfactual Action Log 124, which details the top-N alternative actions that were evaluated but rejected, including their cost decompositions (e.g., collision risk vs. comfort) and feasibility classifications.

To ensure legal and safety accountability, the Regulatory Compliance Annotation 125 maps the intervention against specific standards such as FMVSS 127 or UN R152. This section includes threshold comparisons and a compliance flag (Compliant, Non-Compliant, or Marginal) generated by the system's rules engine. Finally, the Audit Chain linkage fields 126 secure the entire structure. These fields include a SHA-256 hash of the preceding record and the current payload, a 71-byte ECDSA P-256 digital signature, and the HSM Key ID, ensuring the record remains immutable and verifiable within the broader audit chain.

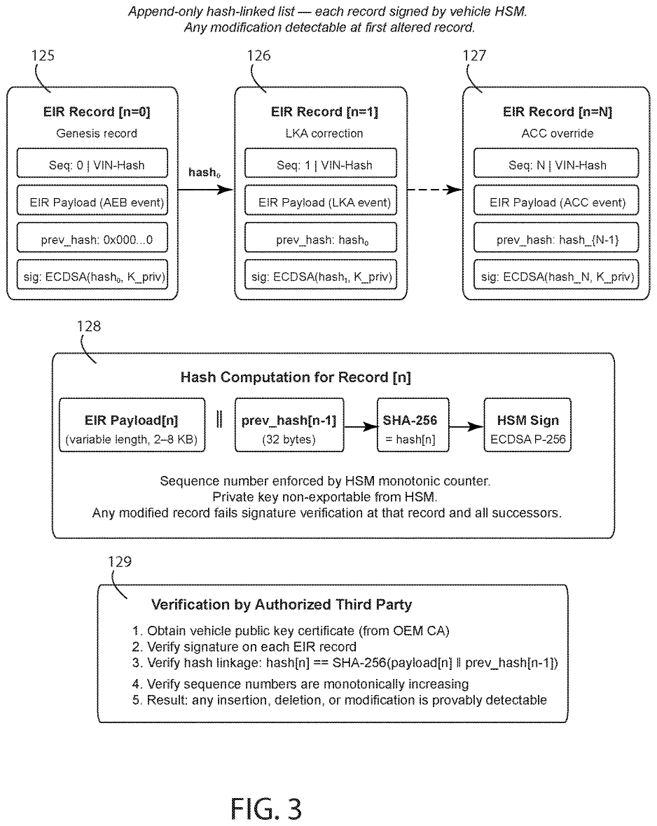

FIG. 3 is a diagram illustrating the tamper-evident Audit Chain data structure, showing an EIR Record baseline, referred to as a genesis record 125, an EIR Record for Lane Keeping Assist (LKA) correction and an EIR Record for Adaptive Cruise Control (ACC) Override 127, in a hash-linked chain, the hash computation formula for each record 128, and the verification workflow for authorized third-party auditors 129.

The broader longitudinal structure of these records is shown in FIG. 3, which depicts an append-only, hash-linked list designed to make any modification immediately detectable. The chain begins with a Genesis Record 125 and grows with each subsequent event, such as a Lane Keeping Assist correction 126 or an Adaptive Cruise Control override 127. To maintain this chain, the system performs a Hash Computation 128 for each new record $n$ by concatenating the serialized payload with the hash of the preceding record and processing it through a SHA-256 algorithm. This creates an inextricable link where hash[n]=\text{SHA-256}(payload[n]\parallel prev\_hash[n−1]). The resulting hash is then signed by the Hardware Security Module 117 using an ECDSA P-256 digital signature. Because the private key is non-exportable and the HSM 117 enforces a monotonic sequence counter, the system is protected against both unauthorized tampering and replay attacks.

Referring to to FIGS. 2 and 3, the Tamper-Evident Audit Chain Manager (Module 4) 140 receives the completed EIR payload from Modules 2 and 3, formats it according to the EIR schema, and incorporates it into the Audit Chain. The EIR schema comprises a fixed-format header section containing the record sequence number, timestamp, vehicle identification number hash, event type, and ADAS architecture class; five payload sections corresponding to the Sensor Input Snapshot, Decision Pathway Record, Structured Causal Narrative, Counterfactual Action Log, and Regulatory Compliance Annotation; and a linkage section containing the hash of the preceding record, the hash of the current record's payload concatenated with the preceding record's hash, and the digital signature over the linkage hash.

The hash computation for record n in the Audit Chain is defined as: hash[n]=SHA-256(payload[n]∥prev_hash[n−1]), where ∥ denotes byte concatenation, payload[n] is the serialized EIR payload bytes, and prev_hash[n−1] is the thirty-two-byte SHA-256 hash of the preceding record. For the genesis record (n equals zero), prev_hash is set to a thirty-two-byte null value. This construction creates an inextricable mathematical link between each record and all preceding records: any modification to a record, any deletion of a record from the chain, or any insertion of a spurious record into the chain will cause hash verification to fail at the first modified or inserted record and at all subsequent records in the chain.

The digital signature over each EIR record is computed by the vehicle's HSM using the ECDSA P-256 algorithm over the record's hash value. The signing operation is performed within the HSM's trusted execution environment using a private key provisioned at the vehicle's factory assembly and stored in the HSM's non-exportable key storage. The HSM enforces a monotonically increasing sequence number counter that increments with each signing operation and cannot be decremented or reset; this prevents replay attacks in which an attacker attempts to substitute a valid older record for a newer record with the same sequence number.

The corresponding public key certificate for the vehicle's signing key is issued by the OEM's certificate authority and registered in the OEM's public key infrastructure. Any authorized party—including regulators, courts, insurers, and independent auditors—can verify the authenticity and integrity of any EIR record by: (a) obtaining the vehicle's public key certificate from the OEM's certificate authority; (b) verifying the digital signature on the record using the public key; (c) verifying the hash chain linkage by recomputing hash[n] from the record payload and prev_hash and confirming it matches the signed hash value; and (d) verifying the sequence number is monotonically consistent with adjacent records.

The signed EIR records are written to a dedicated partition of write-once non-volatile memory (WORM NVM) that is physically and logically isolated from the vehicle's main storage. WORM NVM enforces an append-only write policy in hardware: existing records cannot be modified or deleted, and only new records can be written at the current write pointer position. A typical EIR record occupies between two and eight kilobytes depending on the ADAS architecture type and number of counterfactual alternatives logged. A vehicle accumulating approximately two hundred ADAS interventions per year would generate approximately 1.6 megabytes of Audit Chain data per year. A 32-gigabyte WORM NVM partition provides storage capacity sufficient for the vehicle's operational lifetime.

The system implements a configurable retention policy that specifies minimum and maximum retention periods for EIR records, configurable per jurisdiction to comply with applicable regulatory or insurance record retention requirements. Records that have been successfully transmitted to and verified on the OEM's compliance server are marked as archived in the local WORM NVM metadata but cannot be deleted; they remain in WORM NVM for the vehicle's operational lifetime.

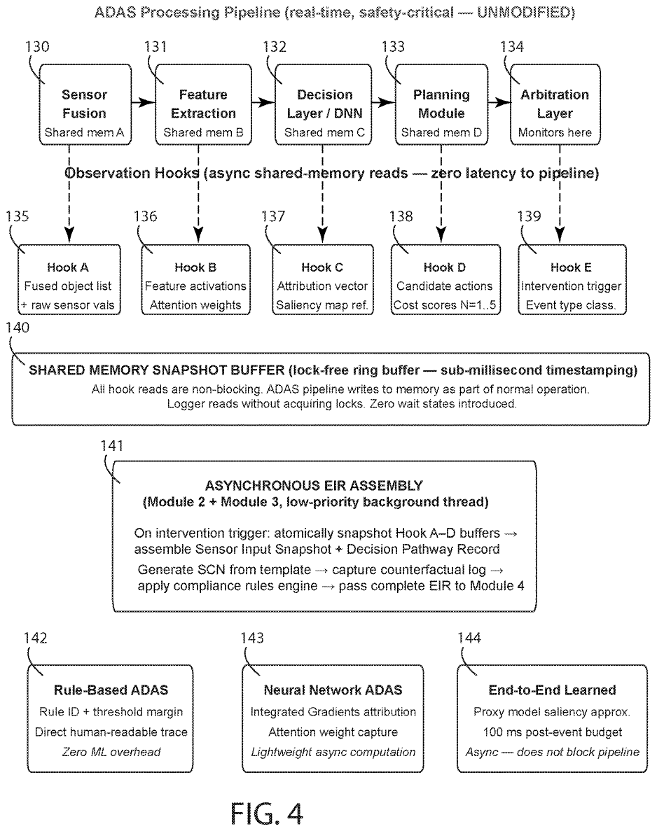

As illustrated in FIG. 4, the system interfaces with a real-time, safety-critical ADAS Processing Pipeline consisting of Sensor Fusion 130, Feature Extraction 131, a Decision Layer 132, a Planning Module 133, and an Arbitration Layer 134. This pipeline remains entirely unmodified throughout the logging process, as the Inference Trace Recorder utilizes a non-intrusive instrumentation architecture. Specifically, the system employs a series of Observation Hooks 135-139 that perform asynchronous shared-memory reads from specific regions the ADAS pipeline writes to during its normal operation. This passive approach ensures that the logging system observes data with zero latency impact on the critical vehicle control path.

Each hook is strategically positioned to capture unique data points from different stages of the processing flow. Hook A 135 extracts the fused object list and raw sensor values from the Sensor Fusion 130 stage, while Hook B 136 captures intermediate feature activations or neural weights from Feature Extraction 131. Decision-relevant data, such as attribution vectors and saliency map references, are gathered by Hook C 137 from the Decision Layer 132. To preserve the logic of rejected maneuvers, Hook D 138 monitors the Planning Module 133 to record candidate actions and their associated cost scores. Finally, Hook E 139 monitors the Arbitration Layer 134 for specific intervention triggers and event classifications, acting as the primary signal to “freeze” the logging buffers.

The technical implementation of this architecture relies on a Shared Memory Snapshot Buffer 140, designed as a lock-free ring buffer with sub-millisecond timestamping. Because the hook specifications—such as memory addresses and data layouts—are parameterized during vehicle platform configuration, the system is fundamentally model-agnostic. All timestamped snapshots are deposited into the ring buffer, from which the Asynchronous EIR Assembly 141 process (comprising Modules 2 and 3) reads in a low-priority background thread. This two-stage architecture allows the system to snapshot the data from Hooks A-D the moment Hook E 139 detects a qualifying intervention, assembling the Sensor Input Snapshot and Decision Pathway Record without consuming the ADAS pipeline's primary compute resources.

The system adapts its decision-capture method to suit the specific ADAS architecture in use. For a Rule-Based ADAS 142, the recorder documents rule identifiers and threshold margins to provide a human-readable trace with zero machine learning overhead. For a Neural Network ADAS 143, the system utilizes integrated gradients and attention weight capture to generate feature attributions asynchronously. In cases of End-to-End Learned 144 systems, where the entire inference pipeline is a single unified model, the recorder employs a lightweight proxy model to approximate gradient saliency within a bounded 100 ms post-event budget. This ensures that regardless of whether the vehicle uses modular rules or deep learning, the resulting Explainable Intervention Record provides a consistent and transparent narrative of the vehicle's behavior.

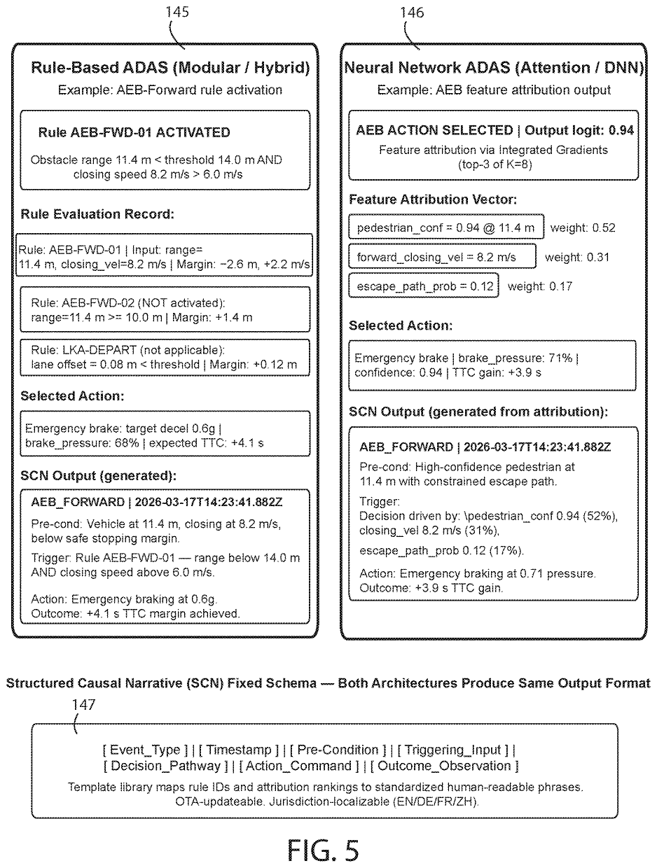

FIG. 5 is a side-by-side comparison diagram showing the inference trace capture output for a rule-based ADAS architecture 145 (rule activation trace with threshold margins) and a neural network ADAS architecture 146 (feature attribution vector with contribution weights), both mapped to the same Structured Causal Narrative output schema with an example AEB intervention 147.

As illustrated in FIG. 5, the system translates complex computational data into a Structured Causal Narrative (SCN), providing a machine-generated, human-readable explanation of intervention decisions in a legally interpretable format. This narrative is generated from the combination of the sensor input snapshot and the decision pathway capture, ensuring that the vehicle's “reasoning” is transparent to non-technical stakeholders. The SCN follows a fixed six-element schema, which includes the event type and precise timestamp, a pre-condition description of the environmental state, and the identification of the specific triggering input—such as a fused state estimate—that crossed the activation threshold. The record further includes a decision pathway summary that translates the internal logic into plain language, a description of the selected action and its intended effect, and an outcome observation that documents the vehicle's state change in the two seconds following the event.

The figure highlights the system's ability to produce a uniform output from different internal architectures. On the left, a Rule-Based ADAS example 145 shows how the SCN is derived from specific rule activations, such as an AEB-forward rule triggered by an obstacle range falling below a 14.0-meter threshold. On the right, a Neural Network ADAS example 146 demonstrates the same result achieved through feature attribution vectors, where the system identifies that a pedestrian detection with a 52\% weighting was the primary driver for the intervention. Despite these different underlying processes, both architectures utilize the Fixed Schema to produce a consistent narrative, ensuring that a “AEB_FORWARD” event is documented identically regardless of the vehicle's software model.

This standardization is made possible by a pre-configured Template Library that maps technical identifiers and attribution rankings to human-readable phrase patterns. This library is stored within the ADAS compute module and is designed to be highly adaptable; it can be updated via over-the-air (OTA) firmware updates to keep pace with changing legal or regulatory requirements. Additionally, the library supports multiple language localizations, allowing the system to generate jurisdiction-appropriate narratives—such as those in English, German, French, or Chinese—from the same underlying data representation. This ensures that the Explainable Intervention Record remains globally compliant and accessible to regulators, insurers, and courts across different markets.

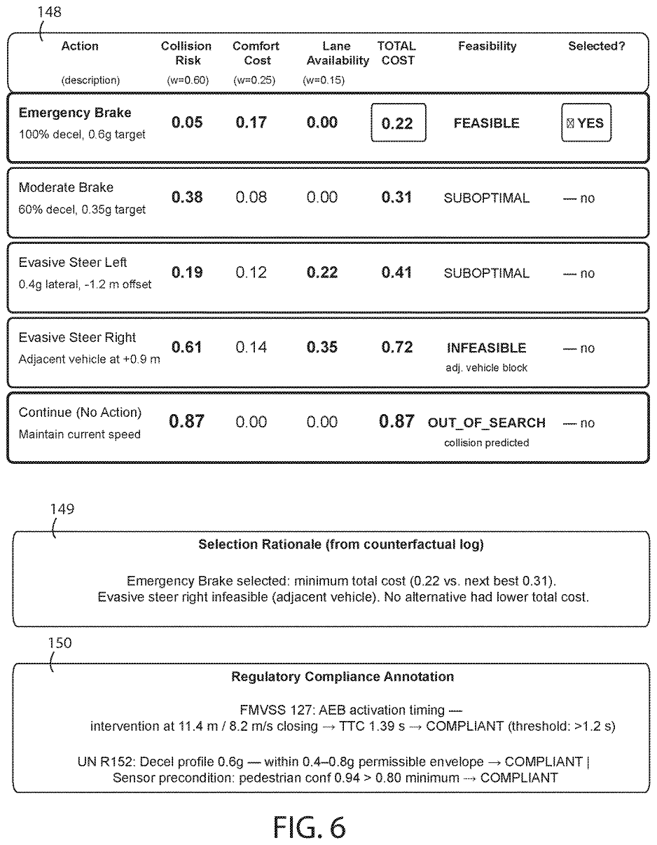

FIG. 6 provides a detailed example of a logged Autonomous Emergency Braking (AEB) intervention, illustrating the “path not taken” through a Counterfactual Action Log 148. This log, captured by the Counterfactual Action Logger via Hook D, records the top-N alternative actions—nominally five—evaluated by the Planning Module during the specific decision cycle. The table displays a range of candidates, including Emergency Brake, Moderate Brake, Evasive Steer Left, Evasive Steer Right, and Continue (No Action). Each candidate is meticulously annotated with a cost decomposition across three primary vectors: Collision Risk (w=0.60), Comfort Cost (w=0.25), and Lane Availability (w=0.15). By recording the specific weights assigned to these components, the system allows third parties to understand not just the total cost of a maneuver, but the specific priorities that drove the final ranking.

The Selection Rationale 149 synthesizes this data to justify the system's choice. In the illustrated example, the Emergency Brake was selected because it offered the minimum total cost (0.22) compared to the next best alternative (0.31). This rationale is further supported by a Feasibility Classification, which categorizes each alternative as FEASIBLE, INFEASIBLE, or OUT_OF_SEARCH. This classification is legally critical; for instance, the log notes that an Evasive Steer Right was INFEASIBLE due to an adjacent vehicle. Distinguishing between an action that was rejected because it was “suboptimal” versus one that was physically “blocked” provides a robust factual basis for defending the system's performance in regulatory or legal reviews, proving that the executed action was the best available option under the circumstances.

The Regulatory Compliance Annotation 150 performs an automated audit of the selected action against established safety standards. The annotation engine evaluates parameters such as intervention timing (Time-to-Collision) and the deceleration profile against requirements like FMVSS 127 and UN R152. In this instance, the system confirms that the activation timing ($1.39\text{s}$) and the $0.6\text{g}$ deceleration profile were both COMPLIANT with their respective thresholds. This rules-based engine is stored as an OTA-updateable module, allowing manufacturers to update regulatory thresholds or add new standards as they evolve without requiring a full ADAS firmware overhaul. By recording the rules engine version within each EIR, the system ensures that every intervention is viewed through the precise regulatory lens that existed at the moment the decision was made.

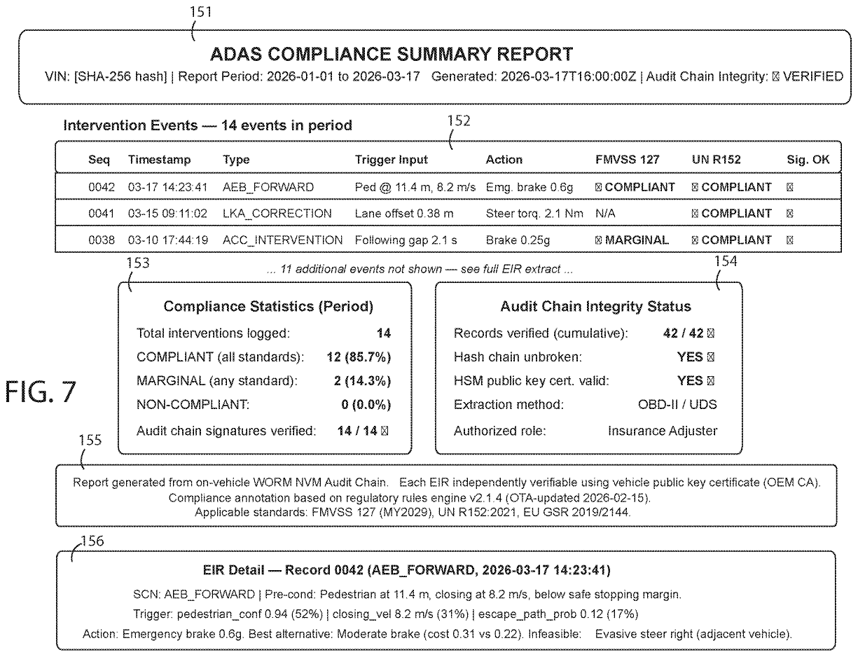

As illustrated in FIG. 7, the ADAS Compliance Summary Report 151 acts as the final output of the logging system, aggregating Explainable Intervention Record (EIR) data into a structured, high-level document suitable for legal and regulatory review. The report header 151 establishes the context of the audit, including the vehicle's VIN hash, the specific reporting period, and a high-level confirmation of the audit chain's integrity. The primary data is organized into an Intervention Events table 152, which provides a chronological list of actions such as AEB activations or LKA corrections. This table maps each event to its precise timestamp, the triggering sensor input, and the resulting actuator command, while providing immediate visual “Compliant” or “Marginal” status indicators against multiple safety standards like FMVSS 127 and UN R152.

To provide a quantitative overview of vehicle performance, the report includes a Compliance Statistics 153 section. This area summarizes the total number of interventions logged during the period and calculates the compliance rate, highlighting any marginal or non-compliant events that may require further investigation. Supporting these statistics is the Audit Chain Integrity Status 154, which serves as a cryptographic health check. It confirms that the cumulative records have been verified, the hash chain remains unbroken, and the Hardware Security Module (HSM) public key certificate is valid. This section also documents the extraction method and the authorized role of the person accessing the data, ensuring the audit trail remains secure and subject to the proper access controls.

The report features an EIR Detail expansion 156, which provides the full Structured Causal Narrative (SCN) for a selected event. This expansion translates technical data into a human-readable format, explaining the pre-conditions—such as a vehicle closing on a pedestrian—and the specific selection rationale that led the system to choose a particular action over its best counterfactual alternative. The entire report is anchored by a cryptographic attestation 155, which specifies the version of the regulatory rules engine used and the applicable safety standards. This attestation ensures that the report is a complete and accurate reflection of the on-vehicle WORM NVM Audit Chain, providing a provable “truth” for insurers, regulators, and courts.

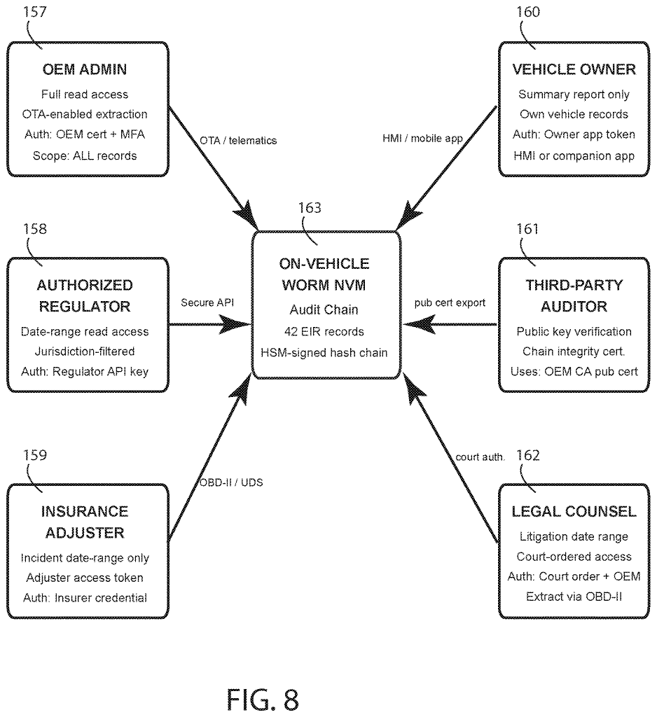

As illustrated in FIG. 8, the system implements a robust Role-Based Access Control (RBAC) framework and extraction workflow to manage how different stakeholders interact with the On-Vehicle WORM NVM repository 163. This central hub, which stores the HSM-signed audit chain, ensures that data remains secure while providing the necessary transparency for legal, insurance, and regulatory purposes. Access is strictly segmented into six distinct roles, each defined by a specific authentication path, a unique set of credentials, and a tailored scope of data visibility.

For remote oversight and system maintenance, the OEM Administrator 157 utilizes an OTA/Telematics path to perform full-read extractions. This high-level access is secured via an OEM certificate paired with multi-factor authentication (MFA), allowing for the management of all records across the fleet. In a similar vein, an Authorized Regulator 158 can access jurisdiction-filtered records through a Secure API. By using a dedicated regulator API key, they are restricted to viewing only the records within a specified date range and geographical boundary, ensuring compliance with local privacy and oversight laws.

On-Site data retrieval for incident analysis is typically conducted via the vehicle's physical diagnostic ports. An Insurance Adjuster 159 connects through the OBD-II/UDS interface to extract data specifically associated with an incident date range, authenticated by an adjuster access token and insurer credentials. This same interface is used by Legal Counsel 162 to execute court-ordered extractions. Their access is tightly bound to the litigation date range specified in the court order, providing a forensic factual basis for legal proceedings and legal counsel 162.

The system also caters to user-facing and verification needs through specialized channels. The Vehicle Owner interacts with the system via the vehicle's HMI or a companion mobile application, using an owner app token to access human-readable Compliance Summary Reports for their own vehicle. Meanwhile, a Third-Party Auditor 161 can perform a public certificate export to verify the chain's integrity. By utilizing the OEM Certificate Authority's public certificate, the auditor can confirm that the cryptographic hash chain is unbroken without needing access to the sensitive private details of the individual records, thereby maintaining the balance between auditability and data privacy.

1. An advanced driver assistance system (ADAS) intervention logging apparatus for a vehicle, comprising:
an intervention event detector in communication with an ADAS arbitration layer, the detector comprising a protected memory region containing a rolling circular pre-event sensor buffer; and
an inference trace recorder comprising a plurality of read-only shared-memory observation hooks coupled to distinct stages of an ADAS processing pipeline; and
a counterfactual action logger comprising a memory-resident counterfactual data structure including a plurality of candidate trajectory fields and corresponding feasibility status indicators; and
a tamper-evident audit chain manager comprising a cryptographic processor and a write-once non-volatile memory (WORM NVM), the cryptographic processor including logic to generate a hash-linked chain of explainable intervention records (EIRs) for storage in the WORM NVM.

2. The apparatus of claim 1 wherein:
the plurality of read-only shared-memory observation hooks comprise memory-address pointers directed to specific shared-memory regions assigned to the ADAS processing pipeline, the pointers providing non-blocking read access to ADAS internal states.

3. The apparatus of claim 1 wherein:
the rolling circular pre-event sensor buffer comprises a lock-free data structure sized to retain a minimum of five seconds of compressed sensor fusion outputs.

4. The apparatus of claim 1 wherein:
the inference trace recorder further comprises an over-the-air (OTA) updateable template library stored in a configuration partition, the template library comprising a mapping of machine-level feature attributions to human-readable phrase patterns.

5. The apparatus of claim 1 wherein:
the counterfactual data structure comprises a cost decomposition matrix having dedicated data fields for collision risk weights, passenger comfort weights, and lane availability weights.

6. The apparatus of claim 1 further comprising:
a hardware security module (HSM) physically isolated from the ADAS processing pipeline, the HSM comprising:
non-exportable key storage containing a private cryptographic key; and
a monotonic hardware counter coupled to a digital signature engine for enforcing unique sequence numbers within the hash-linked chain.

7. The apparatus of claim 1 further comprising:
a regulatory compliance annotation engine including a rules-based processor in communication with a version-controlled regulatory threshold database.

8. The apparatus of claim 1 further comprising:
a data extraction interface selected from a group consisting of an OBD-II port and a telematics transceiver, the interface being coupled to a role-based access control (RBAC) gateway.

9. The apparatus of claim 8 wherein:
the RBAC gateway comprises a credential verification module configured to apply distinct data-masking filters to EIR data based on an authenticated user role.

10. The apparatus of claim 1 wherein:
the WORM NVM comprises a hardware-locked append-only partition logically separated from the vehicle's primary operating system storage.

11. A method for using the apparatus of claim 1 comprising:
monitoring an ADAS arbitration layer via a non-intrusive instrumentation architecture to detect a qualifying intervention event; and
freezing a rolling circular buffer containing processed sensor fusion data upon detection of the event; and
capturing intermediate feature representations from a plurality of stages of an ADAS processing pipeline using asynchronous shared-memory reads; and
logging a plurality of counterfactual actions considered by a planning module of the ADAS processing pipeline, including a reason for rejection for each counterfactual action; and
generating an explainable intervention record (EIR) formatted according to a standardized schema; and
cryptographically linking e EIR to a previous EIR in an append-only audit chain; and
writing the EIR to an immutable WORM storage medium.

12. The method of claim 11 further comprising:
generating a structured causal narrative for the EIR by mapping technical feature attributions to human-readable phrase patterns stored in an over-the-air (OTA) updateable template library.

13. The method of claim 11 wherein:
logging counterfactual actions includes recording a feasibility classification of INFEASIBLE if a candidate trajectory was blocked by a detected physical obstacle in the vehicle's environment.

14. The method of claim 11 further comprising:
verifying the integrity of the audit chain by recomputing a SHA-256 hash for each EIR in the chain; and
confirming a digital signature of each EIR using a public key certificate associated with a hardware security module of the vehicle.

15. The method of claim 11 further comprising:
extracting a compliance summary report via an OBD-II diagnostic interface; wherein
the depth of data extracted is determined by an authenticated user role.

16. An advanced driver assistance system (ADAS) intervention logging apparatus for a vehicle, comprising:
an intervention event detector configured to monitor an ADAS arbitration layer to identify a qualifying intervention event, wherein the intervention event detector maintains a rolling pre-event sensor buffer that is frozen upon detection of the qualifying intervention event
an inference trace recorder configured to capture, via a plurality of non-intrusive observation hooks, a set of sensor inputs and intermediate feature representations from an ADAS processing pipeline at the time of the qualifying intervention event; and
a counterfactual action logger configured to capture a plurality of alternative actions evaluated by the ADAS processing pipeline but not executed, including a feasibility classification for each alternative action; and
a tamper-evident audit chain manager configured to aggregate data from the inference trace recorder and the counterfactual action logger into an explainable intervention record (EIR), wherein the audit chain manager computes a cryptographic hash chain linking the EIR to a preceding EIR.

17. The system of claim 16 wherein:
the plurality of non-intrusive observation hooks are configured to perform asynchronous shared-memory reads of specific memory regions written to by the ADAS processing pipeline such that the logging system introduces zero latency to the ADAS processing pipeline.

18. The system of claim 16 wherein:
the qualifying intervention event includes at least one of: an autonomous emergency braking (AEB) activation, a lane keeping assist (LKA) correction, an adaptive cruise control (ACC) intervention, a driver override of an ADAS command, and an autonomous mode disengagement.

19. The system of claim 16 wherein:
the inference trace recorder is model-agnostic and configured to generate a structured causal narrative (SCN) according to a fixed schema comprising: a pre-condition description, a triggering input identification, a decision pathway summary, and an action description.

20. The system of claim 16 wherein:
the counterfactual action logger is further configured to record a cost decomposition for each alternative action, the cost decomposition comprising a collision risk weight, a passenger comfort weight, and a lane availability weight.
